(19) United States
(12) Patent Application Publication
(10) Pub. No.: US 2015/0375726 A1
(43) Pub. Date: Dec. 31, 2015

(54) METHOD FOR OPERATING A BRAKE SYSTEM, BRAKE SYSTEM IN WHICH THE METHOD IS PERFORMED, AND USES OF THE BRAKE SYSTEM

(71) Applicant: CONTINENTAL TEVES AG & CO. OHG, Frankfurt (DE)

(72) Inventors: Georg Roll, Frankfurt (DE); Jürgen Böhm, Oberneisen (DE); Marco Besier, Bad Schwalbach (DE)

(21) Appl. No.: 14/769,182

(22) PCT Filed: Feb. 25, 2014
(86) PCT No.: PCT/EP2014/053652

§ 371 Date: Aug. 20, 2015

(30) Foreign Application Priority Data
Mar. 5, 2013 (DE) 10 2013 203 737.6
Nov. 27, 2013 (DE) 10 2013 224 313.8

(51) Int. Cl. B60T 8/48; B60T 8/40

(52) U.S. Cl. CPC B60T 8/4827; B60T 8/4081

(57) ABSTRACT

A method for operating a motor vehicle brake system, the brake system including an electrically controllable pressure-providing device, including a cylinder/piston assembly having a hydraulic pressure chamber and a piston that can be moved by an electromechanical actuator, a number of hydraulic wheel brakes associated with two axles of the vehicle can be supplied with braking pressure via the hydraulic pressure chamber, and a sensor for detecting the driver braking request. An electric drive having at least one electrical machine, which can also be operated as a generator, is associated with at least one axle of the vehicle, and, during regeneration braking, in which a generator deceleration is built up by the electric drive, the cylinder-piston assembly is controlled such that the pressure in the hydraulic pressure chamber is adjusted in accordance with the difference between the requested braking deceleration and the generator deceleration built up by the electric drive.

### CROSS REFERENCE TO RELATED APPLICATIONS

This application is the U.S. National Phase Application of PCT International Application No. PCT/EP2014/053652, filed Feb. 25, 2014, which claims the priority to German Patent Application No. 10 2013 203 737.6, filed Mar. 5, 2013 and German Patent Application No. 10 2013 224 313.8, filed Nov. 27, 2013, the contents of such applications being incorporated by reference herein.

### FIELD OF THE INVENTION

The invention relates to a method for operating a brake system, a brake system and the use of the brake system.

### BACKGROUND OF THE INVENTION

Motor vehicles having at least partially electric drives which are also known by the term “hybrid vehicles” are growing in popularity. During braking, at least one electrical machine of the electric drive can be operated as a generator in order to recover the kinetic energy of the vehicle as electrical energy and to store it in a battery; this is also known by the term “recuperation”. For maximum energy recovery, it is desirable to apply braking deceleration during a recuperative braking operation as completely as possible by the generator(s) of the electric drive. Since, in a completely charged battery, no more energy can be stored or the electric drive is not always available as a generator, hybrid vehicles are further provided with wheel brakes which are based on friction in order at any time to be able to ensure adequate braking deceleration.

In this instance, it is advantageous for the wheel brakes to be operated in a “brake by wire” mode, that is to say, to be decoupled from the brake actuation by the driver. Consequently, the wheels of the drive axle(s), which is/are therefore intended to be understood to be the electrically driven axle(s) in this instance, can be braked only by the electric drive in particular during braking operations with a low level of deceleration and at the same time a pedal sensation which is comfortable for the driver can be provided via a pedal simulator. For example, the electrohydraulic brake system which is known from DE 10 2010 040 097 A1, which is incorporated by reference, and in which hydraulic wheel brakes are supplied with pressure via an electrically driven cylinder/piston arrangement are controlled in a “brake by wire” operating mode.

During recuperative braking, the brake force distribution is influenced by the drive configuration: if, for example, an internal combustion engine and an electrical machine are arranged in a common drive train which acts on the wheels of a drive axle, there will be produced in the case of pressureless wheel brakes a braking force distribution which is substantially different from the optimum braking force distribution from the point of view of driving stability. Particularly in an electric drive having high power, the following dynamic influences in terms of travel on the driving behavior of the vehicle can be produced depending on the axle on which the generator braking moment acts.

If the generator braking moment acts only on the rear axle (therefore, the electric drive is configured as a rear-wheel drive), the axle can be overbraked, wherein a braking force which is too powerful in relation to the front axle is applied at the rear axle, with the result that a tendency to oversteer may occur. Such overbraking of the rear axle may lead to skidding of the vehicle and is difficult to control for inexperienced drivers.

If the generator braking moment acts only on the front axle, as in a generator arranged in the drive train of a vehicle having front-wheel drive, the axle can be overbraked, wherein the deviation from the ideal braking force distribution is less substantial in the case of deceleration which is applied purely by braking forces at the front axle because a conventional vehicle in any case transmits approximately ⅔ of the braking power thereof via the front axle. Furthermore, overbraking of the front axle leads to a more powerful tendency for the vehicle to understeer, which is less critical in terms of driving dynamics or can generally be controlled more easily by the driver than a tendency to oversteer. Nevertheless, the ability of the vehicle to be steered is also thereby impaired in a negative manner. Furthermore, the generator power of a hybrid vehicle can fluctuate in the course of a braking operation and in particular decrease as far as zero during braking to a stopped state.

### SUMMARY OF THE INVENTION

An aspect of the present invention is to ensure constant deceleration during a recuperative braking operation of a motor vehicle having an electrohydraulic brake system and an electric drive.

Therefore, a method for operating a brake system for motor vehicles is provided, wherein the brake system comprises an electrically controllable pressure provision device which comprises a cylinder/piston arrangement having a hydraulic pressure chamber and a piston which can be displaced by an electromechanical actuator, a number of hydraulic wheel brakes which are associated with two axles of the vehicle and which can be supplied with braking pressure via the hydraulic pressure chamber, and a sensor for detecting the driver's desired braking action. According to the invention an electric drive which can also be operated as a generator and which has at least one electrical machine is associated with at least one axle of the motor vehicle and, during recuperative braking, in which a generator deceleration is produced by the electric drive, the cylinder/piston arrangement is controlled in such a manner that the pressure in the hydraulic pressure chamber is adjusted in accordance with the difference between the required braking deceleration and the generator deceleration produced by the electric drive.

If the electric drive can provide the desired vehicle deceleration alone, a hydraulic pressure build-up does not occur. The recuperative braking is comfortable and efficient. In the event that the generator braking moment is limited as a result of the charge state of the battery, the maximum generator power or a low friction coefficient of the road surface (which requires a suitable braking force distribution between the axles) and cannot completely implement the driver's request, a hydraulic pressure is built up in the wheel brakes of at least one axle in addition by means of an electrically controllable pressure provision device as a pressure source. In this instance, the desired vehicle deceleration, generator braking moment and hydraulic braking force when considered in a common unit are advantageously converted, for example, into an equivalent pressure. The required hydraulic pressure can then be established on the basis of a simple difference generation. By the pressure source having a cylinder/piston arrangement with an electrically displaceable piston, both a pressure increase and a pressure decrease can be brought about without actuation of solenoid valves. This ensures a minimum of noise pollution and a high level of driving comfort.

According to a preferred embodiment of the invention, all the wheel brakes are connected to the hydraulic pressure chamber during recuperative braking. The braking pressure can then be adjusted in all the wheel brakes directly via the system pressure in the cylinder/piston arrangement. Valve actuations which are critical in terms of noise generation are not produced.

According to an alternative preferred embodiment of the invention, the wheel brakes are or become separated at least temporarily from the hydraulic pressure chamber during recuperative braking at one axle, on which the electric drive which is operated as a generator acts. This allows selective influence of the braking force distribution between the axles.

In this instance, it is particularly preferable for at least each wheel brake which is associated with an electrically driven axle to act on the electric drive which is operated as a generator, in particular each wheel brake of the motor vehicle, to have an inlet valve, in particular a solenoid valve which is opened without current, which is arranged between the hydraulic pressure chamber and wheel brake and an outlet valve, in particular a solenoid valve which is closed without current, which is arranged between the wheel brake and a pressureless storage container, wherein the braking pressure during recuperative braking is modulated in at least one, in particular all, wheel brake(s) which is/are associated with the electrically driven axle by the inlet valves and/or the outlet valves being switched. Optimum braking force distribution can thereby also be maintained when the generator braking moment fluctuates.

Alternatively, in this instance, it is particularly preferable for at least each wheel brake which is associated with an electrically driven axle on which the electric drive operated as a generator acts, in particular each wheel brake of the motor vehicle, to have an inlet valve, in particular a solenoid valve which is opened without current, which is arranged between the hydraulic pressure chamber and the wheel brake, wherein the wheel brakes of the electrically driven axle are separated from the hydraulic pressure chamber for the entire duration of recuperative braking. By the wheel brakes of the electrically driven axle being separated, overbraking of that axle can be reliably prevented by a hydraulic pressure build-up. A decreasing generator braking moment can be compensated for by pressure build-up in the wheel brakes of the other axle.

It is very particularly preferable for the duration of the recuperative braking to be established on the basis of the driver's desired braking action or a stopping of the motor vehicle, wherein in particular the wheel brakes associated with an electrically driven axle are also separated from the hydraulic pressure chamber when the generator deceleration has been selected to be zero and has been replaced completely by hydraulic braking pressure.

It is advantageous for the brake system to further have a main brake cylinder which can be actuated by the driver via a brake pedal and which is connected to all the wheel brakes via brake lines, and at least one separation valve, in particular a solenoid valve which is opened without current, which is arranged between the main brake cylinder and the wheel brakes, wherein the main brake cylinder is separated from the wheel brakes during recuperative braking. The main brake cylinder provides a hydraulic fallback arrangement by means of direct actuation of the wheel brakes with muscle power. A reduced level of efficiency of the recuperation as a result of an undesirable pressure build-up can be prevented by it being separated during recuperative braking.

It is particularly advantageous for the brake system to further have a pedal simulator which can be connected to the main brake cylinder via a simulator valve, in particular a solenoid valve which is closed without current, wherein the simulator valve is opened during regenerative braking. A constant pedal sensation can be ensured by a pedal simulator irrespective of whether braking is carried out in a recuperative manner or in a purely hydraulic manner. In this instance, it is advantageous for the pedal simulator to take up the brake fluid volume which would be taken up in the wheel brakes during purely hydraulic braking with a corresponding vehicle deceleration. In addition, there may also be provision for adjusting a suitable pedal characteristic line or pedal counter-force by means of resilient elements or an electromechanical actuator.

Furthermore, it is particularly advantageous for an actuation displacement sensor which is arranged on the brake pedal or the main brake cylinder and/or a pressure sensor which is connected to the main brake cylinder to be evaluated as a sensor for detecting the driver's desired braking action. The evaluated sensor can advantageously be selected in accordance with the extent of the actuation.

Preferably, the entire braking deceleration required is built up by the electric drive up to a predetermined maximum value, wherein the maximum value is particularly selected in accordance with the generator power and/or the vehicle speed and/or the charge level of a battery which is connected to the electric drive. By the generator deceleration available under the current operating conditions being completely used before the wheel brakes are actuated, particularly efficient recuperation can be ensured.

It is advantageous for a wheel speed sensor to be arranged on each wheel of the motor vehicle, wherein the generator deceleration is limited or reduced if a slippage magnitude which is established on the basis of the wheel speeds, in particular a relationship between a wheel speed of a wheel connected to the electric drive and a free-wheeling wheel, exceeds a predetermined slippage threshold value. Consequently, overbraking of the electrically driven axle can be limited or avoided in a preventive manner.

An aspect of the invention further relates to a brake system for a motor vehicle, having an electrically controllable pressure provision device which comprises a cylinder/piston arrangement having a hydraulic pressure chamber and a piston which can be displaced by an electromechanical actuator, having a number of hydraulic wheel brakes which are associated with two axles of the motor vehicle and which can be supplied with braking pressure via the hydraulic pressure chamber, and having a sensor for detecting the driver's desired braking action. An electric drive which can also be operated as a generator and which has at least one electrical machine is associated with at least one axle of the vehicle, and the brake system comprises an electronic control device which carries out a method according to the invention.

An aspect of the invention further relates to the use of a brake system according to the invention in a motor vehicle.

If the electric drive is arranged at the front axle of the motor vehicle, all the wheel brakes are advantageously connected to the hydraulic pressure chamber and the electrically controllable pressure source is controlled in accordance with the difference between the driver's desired braking action and the current generator braking moment. As a result of the axial load displacement or the higher braking moments which can be produced at the front axle, the driving stability remains safe; valve actuation operations which are critical with regard to noise nuisance are substantially prevented.

If an electric drive is associated with the rear axle of the motor vehicle, it is advantageous for the wheel brakes of the rear axle to be at least temporarily separated from the hydraulic pressure chamber. By those wheel brakes being separated, overbraking of the rear axle can be reliably prevented.

### BRIEF DESCRIPTION OF THE DRAWINGS

Preferred embodiments will be appreciated from the dependent claims and the following description of an embodiment with reference to Figures. In the drawings:

FIG. 1 is a schematic illustration of a motor vehicle,

FIG. 2 is a schematic illustration of an active brake system which can be controlled with a method according to the invention,

FIG. 3 shows an active brake system in another valve switching state,

FIG. 4 shows a braking operation according to a first embodiment of the invention,

FIG. 5 shows a braking operation according to a second embodiment of the invention, and

FIG. 6 shows a braking operation according to a third embodiment of the invention.

### BRIEF DESCRIPTION THE PREFERRED EMBODIMENTS

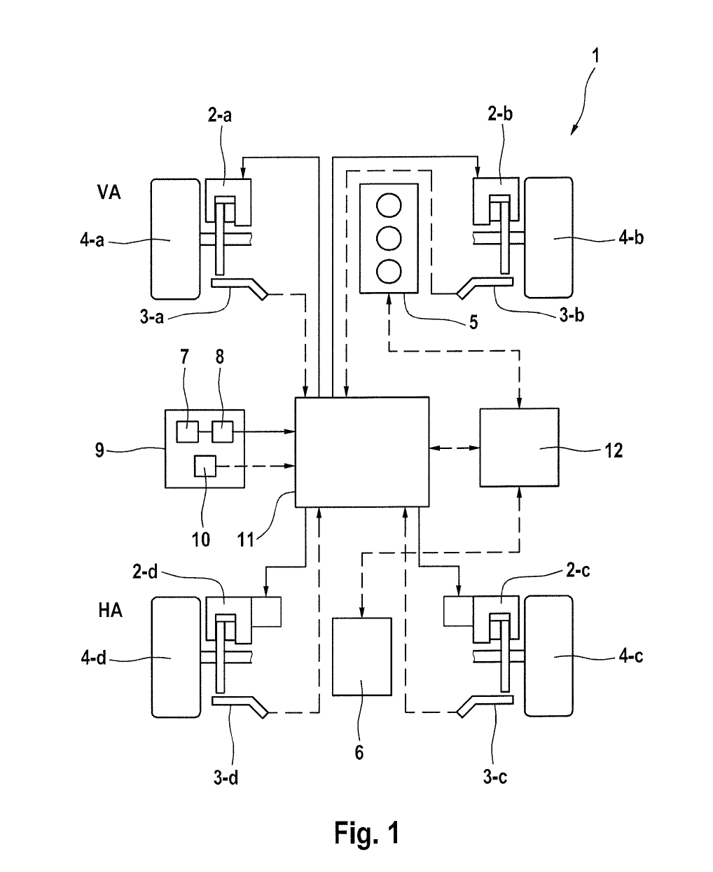

FIG. 1 shows a motor vehicle 1 which has a brake system which is suitable for carrying out the method according to the invention. The exemplary vehicle is a hybrid vehicle which comprises an internal combustion engine 5 and an electric drive 6 having one or more electrical machines which can be controlled as a generator in order to charge the battery in order to charge one or more vehicle batteries which are not shown. In order to control the electric drive, there is provided a motor control unit 12 which is connected to an electrohydraulic control device 11 of the brake system. In the example shown, the electric drive 6 acts on the rear axle HA of the vehicle. In principle, a method according to the invention may be used irrespective of which wheels 4-a, 4-b, 4-c, 4-d are braked in a recuperative manner in addition to the friction brakes 2-a, 2-b, 2-c, 2-d, in particular an electric drive which is connected only to the front axle VA may alternatively be provided.

The wheels of one or more axles can be connected to an electrical machine which is arranged in the drive train, but a configuration having wheel hub motors on the wheels of at least one axle can also be controlled with a method according to the invention. As will be explained below, different embodiments of a method according to the invention are particularly advantageous in accordance with the drive configuration and power of the electrical machine.

A desired braking action of the driver is established via a brake actuation unit 9 which comprises a brake pedal 7, a main brake cylinder 8 and at least one sensor 10 for detecting the driver's desired braking action. This unit transmits braking means (illustrated as a solid line) and electrical signals (illustrated as a broken line) to the electrohydraulic control device 11 and can preferably also be integrated therein in a housing. The vehicle has wheel speed sensors 3-a, 3-b, 3-c, 3-d which also transmit their signals to the electrohydraulic control device 11, whereby, for example, a slippage control of the braking pressure in the individual wheel brakes 2-a, 2-b, 2-c, 2-d can be carried out. The electronic brake control device 11 and motor control unit 12 exchange information required for a recuperative braking operation, such as the present vehicle speed and the currently available generator deceleration and the maximum possible generator braking moment.

If the driver actuates the brake pedal 7, braking of the vehicle is preferably carried out only by the generator 6, wherein the brake medium volume displaced by the main cylinder 8 is preferably discharged into a pedal simulator. In the case of a road surface with a low friction coefficient, it may be the case with only one electrically driven axle that the drive wheels can no longer transmit the braking force and the wheel speed thereof decreases substantially. In order to avoid a loss of the driving stability, the recuperative braking moment then has to be limited by means of methods which are known per se. If, in the case of brake actuation, the battery is already fully charged, the entire deceleration requirement of the driver is implemented by means of a hydraulic pressure build-up in the wheel brakes. In this instance, the vehicle's kinetic energy to be discharged is converted into heat.

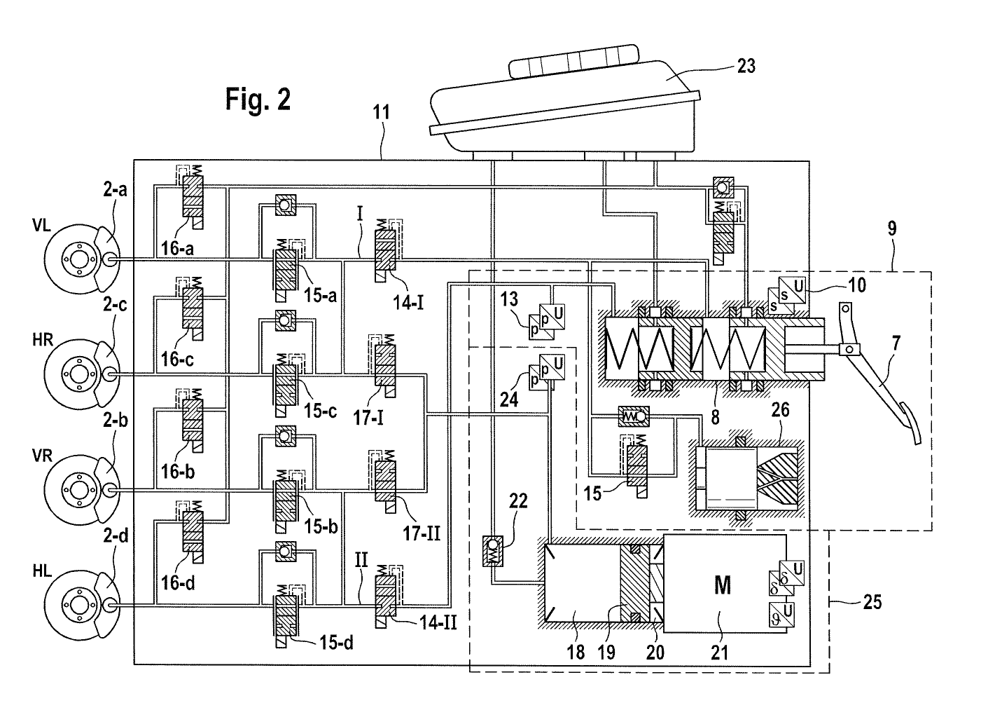

FIG. 2 is a schematic illustration of an active brake system, in which an electrically controllable pressure provision device can produce a braking pressure, which can be controlled with a method according to the invention, independently of the driver.

A brake actuation unit 9 serves to detect a deceleration requirement of the driver and to provide a pleasant pedal sensation. By means of the brake pedal 7, the driver actuates a main brake cylinder 8, in particular a tandem main brake cylinder, wherein the brake actuation can be detected by means of an actuation displacement sensor 10 and/or a pressure sensor 13 which is hydraulically connected to the main brake cylinder 8. If the brake system is controlled in a “brake by wire” operating mode, the main brake cylinder 8 is hydraulically separated from the wheel brakes 2 and connected via a simulator valve 15 to a pedal simulator 26 which provides a pleasant pedal sensation. That simulator may be constructed, for example, similarly to a low-pressure store having a resiliently loaded piston; alternatively, it is also possible to use a “cap” of elastomer material or an electromagnetic actuator in order to adjust a variable counter-force.

In the brake lines I, II between the main brake cylinder 8 and the wheel brakes 2, there is arranged a separation valve 14-I, 14-II which is particularly constructed as a solenoid valve which is opened without current in order to ensure a minimum deceleration of the motor vehicle 1 in the event of an electrical defect. The main brake cylinder 8 is then directly connected via brake lines I, II to the wheel brakes 2-a, 2-b, 2-c, 2-d which are advantageously arranged in two brake circuits, and a pedal force which is applied by the driver is converted directly into a braking pressure in the wheel brakes.

In the “brake by wire” mode, that is to say, an active operation of the brake system, however, the braking pressure is produced by an electrically controllable pressure provision device 25. This device comprises a hydraulic pressure chamber 18, which is advantageously constructed as a cylinder and in which a piston 19 is arranged in a displaceable manner. The piston 19 is driven by an electromechanical actuator which is preferably constructed from an electric motor 21, in particular an electronically commutated motor having a rotor which comprises permanent magnets, and a rotation/translation gear 20, such as a ball screw. The hydraulic pressure chamber 18 can be connected to the wheel brakes 2-a, 2-b, 2-c, 2-d via connection valves 17-I, 17-II, in particular solenoid valves which are closed without current. On the basis of a rest position, in which the hydraulic pressure chamber has a maximum volume, the piston 19 is moved into a new position in the event of brake actuation by the electromechanical actuator, wherein brake fluid is urged out of the hydraulic pressure chamber 18 and a braking pressure is built up in the wheel brakes 2 via the brake lines. As soon as the piston 19 has been moved or redirected for a pressure build-up, a braking pressure decrease can be brought about equally in all the wheel brakes 2-a, 2-b, 2-c, 2-d by the piston 19 being withdrawn. By the connection valves 17-I, 17-II being closed and the piston 19 being withdrawn, it is also possible to draw in additional brake fluid from a storage container 23 via a non-return valve 22.

In order to allow rapid control of the braking pressure in an individual manner for each wheel, each wheel brake 2-a, 2-b, 2-c, 2-d advantageously has an inlet valve 15-a, 15-b, 15-c, 15-d, in particular a solenoid valve which is opened without current, which is arranged in the brake line between the pressure source and the wheel brake, and an outlet valve 16-a, 16-b, 16-c, 16-d which is arranged between the wheel brake and the storage container. By means of a non-return valve which is arranged parallel to the respective inlet valve 15, the braking pressure in a wheel brake is preferably prevented from exceeding the system pressure in the hydraulic pressure chamber 18. If an inlet valve 15 which is arranged downstream of the pressure sources or separation valve 14 and connection valve 17 is closed, the braking pressure in the associated wheel brake 2 also remains constant in the event of an additional pressure increase. Pressure can then be discharged from the associated wheel brake 2 into the storage container 23 by selectively opening the outlet valve 16.

In the preferred active operation of the brake system, therefore, a system pressure is built up in all the wheel brakes 2 connected in that the piston 19 is moved into the hydraulic pressure chamber 18 by the electromechanical actuator. That system pressure can be measured by means of a pressure sensor 24. If the friction brake power has to be adapted as a result of a changed generator power or a change in the driver's desired braking action, the system pressure is accordingly adapted by the piston 19 being moved. This is carried out imperceptibly for the driver because the electrically controllable pressure provision device 25 is hydraulic from the brake pedal by the separation valves 14-I, 14-II.

If an excessive slippage or blocking of a wheel is established by a wheel speed sensor 3, there is advantageously produced a brake slippage control operation. As already explained, in this instance the system pressure, or by switching the inlet valves 15 which are preferably controllable in an analogue manner and the particularly digitally constructed outlet valves 16, a braking pressure which is individual for each wheel, can be reduced. With regard to details of the control of the active brake system in the context of such a brake slippage control, reference may be made to DE 10 2011 076 675 A1, which is incorporated by reference, and DE 10 2011 077 329 A1, which is incorporated by reference.

If the motor vehicle has, for example, a dynamic vehicle control unit, in particular a yaw rate control unit, or an assistance function, such as an emergency braking assistant, the deceleration requirement can also be carried out by a vehicle control device (not shown) which is connected to the electronic control device 11 of the brake system, for example, via a vehicle data bus. A pressure increase is then always brought about in one or more wheel brakes 2 by means of the electrically adjustable pressure provision device 25.

FIG. 2 shows a switching state of the brake system or the (electro) solenoid valves in which the main brake cylinder 8 is separated from the wheel brakes 2 by the separation valves 14-I, 14-II and the electrically controllable pressure provision device 25 is hydraulically connected to all the wheel brakes 2-a, 2-b, 2-c, 2-d via the connection valves 17-I, 17-II. In the case of recuperative braking, a system pressure is then produced in accordance with the driver's intentions or the requested deceleration in the hydraulic pressure chamber 18 which supplies the friction braking moment required in addition to the generator braking moment by the wheel brakes being actuated at all the wheels.

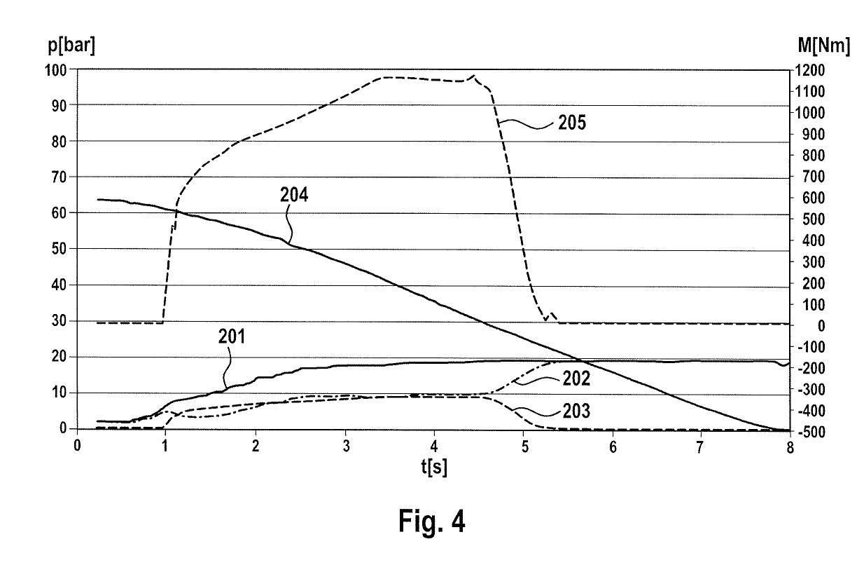

With reference to FIG. 4, there is illustrated an example of a corresponding recuperative braking operation, in which the brake system is controlled in accordance with a first embodiment of a method according to the invention. The electric drive 6 is configured in this instance as an electrical machine which acts on the wheels of an axle, that is to say, a generator axle moment 205 acts on the wheels of the electrically driven axle as the braking moment which is applied by the electrical generator at that axle. For controlling the brake system, it is advantageous to consider the friction braking moment and the generator braking moment in the same unit. Therefore, the generator pressure equivalent is set out in line 203, that is to say, the corresponding system pressure which would be required in order to adjust the generator braking moment by means of the friction brakes. The diagram sets out on the left-hand y-axis a scale of the pressure p and on the right-hand y-axis a scale of the braking moment M, while the x-axis sets out the time t. The deceleration required by the driver is set out in line 201 as a driver's desired pressure; advantageously, it is detected by actuation displacement sensors 10 and/or pressure sensors 13. The generator pressure equivalent 203 therefore indicates the braking pressure which corresponds to the generator axial moment 205 and is advantageously subtracted from the driver's desired pressure 201 in order to establish the required system pressure 202. Consequently, that system pressure 202 is adjusted by the piston 19 being moved in the hydraulic pressure chamber 18 and acts on all the wheel brakes 2 equally. Consequently, the vehicle deceleration corresponding to the driver's desired pressure is produced from the simultaneous optimum use of the wheel brakes on the basis of friction and generator. Line 204 sets out the vehicle speed; the vehicle is braked to a standstill. Since the available generator power decreases substantially below a limit speed, the system pressure is increased approximately at 5 s for compensation.

That first embodiment of a method according to the invention for the combined control of a generator and an electrohydraulic brake system is advantageously used in vehicles having an electric drive 6 of limited power at the rear axle HA (for example, Mild Hybrid or Micro Hybrid), an electric drive 6 having any power at the front axle VA or an electric drive 6 which is connected to both axles of the vehicle since, in those configurations, the risk of overbraking of the wheels HR, HL at the rear axle HA is small. It has the advantage that no additional actuation of electrical solenoid valves is necessary, whereby a development of noise is prevented and the service life of the brake system is not reduced by additional load cycles of the valves.

Additional embodiments of a method according to the invention for adjusting suitable braking pressures during a recuperative braking operation are set out below, wherein an electric drive 6 arranged at the rear axle HA is taken as the basis. In principle, a corresponding control can also be carried out in a generator at the front axle, wherein the control of the inlet valves 15-a, 15-b and outlet valves 16-a, 16-b is then carried out in such a manner that the braking pressure in the wheel brakes 2-a, 2-b of the front axle VA is limited or modulated.

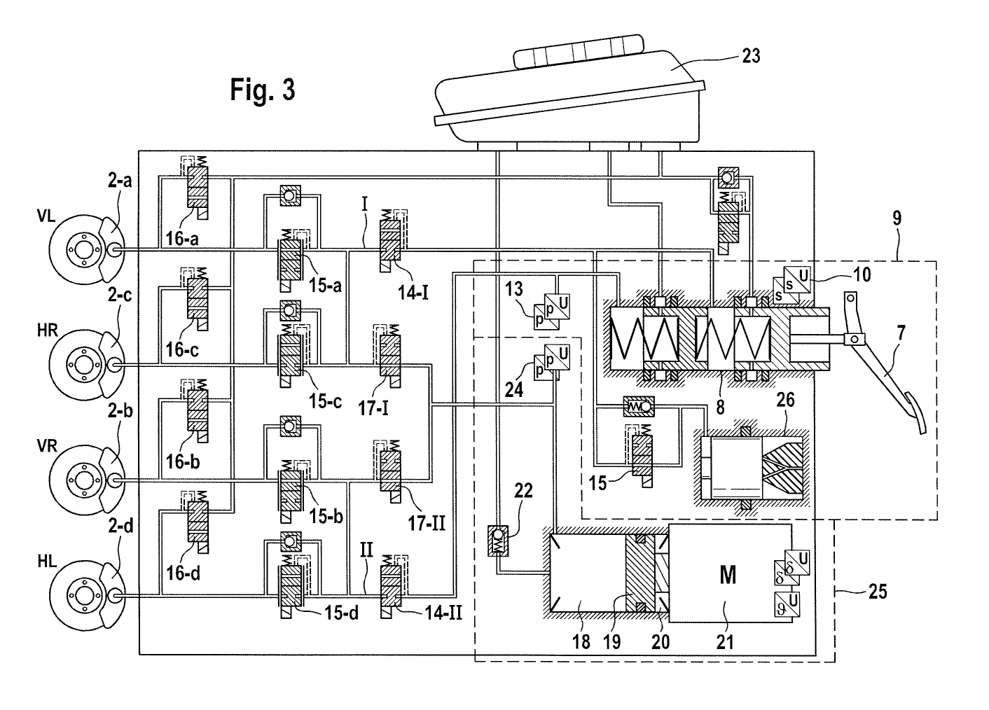

As illustrated in FIG. 3, the inlet valves 15-c, 15-d and optionally the outlet valves 16-c, 16-d of the wheel brakes 2-c, 2-d of the rear axle HA are used to vary the braking pressure in the two associated wheel brake circuits. This makes it possible to prevent overbraking of the electrically driven rear axle in the case of a generator braking moment which acts only on the rear axle HA or not to negatively influence the braking force distribution to such an extent that the vehicle has a tendency to oversteer.

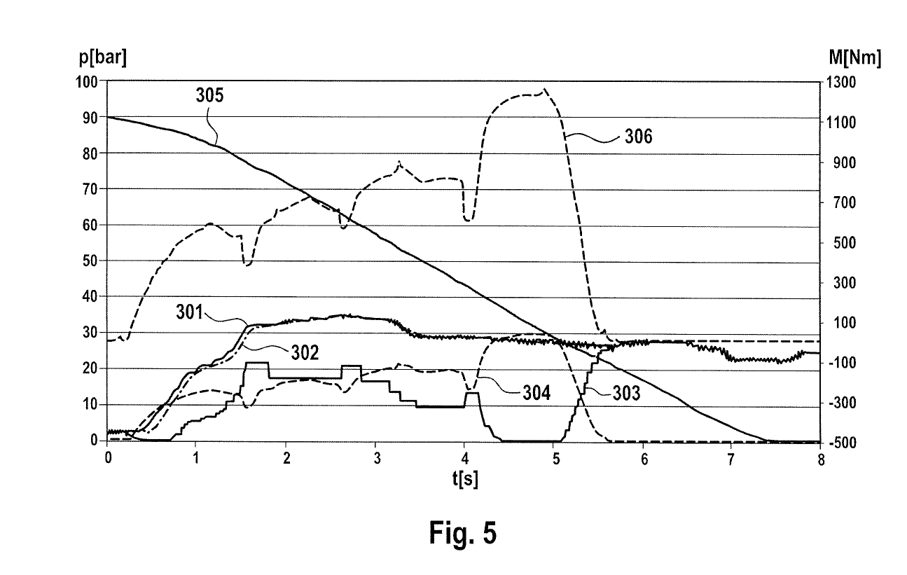

An exemplary braking operation with control of the brake system in accordance with a second embodiment of the invention is shown in FIG. 5 which accordingly sets out pressure p or braking moment M over time t. The driver's desired pressure detected via a sensor is set out in line 301. As may be seen in line 302, the braking pressure in the wheel brakes of the front axle substantially follows the driver's desired pressure. The generator axle moment produced by the electric drive during the braking at the rear axle is set out in line 306. The generator pressure equivalent 304 sets out the corresponding braking pressure in the wheel brakes of the rear axle HA, which pressure is necessary for providing a friction braking moment corresponding to the generator braking moment.

In order to establish the required braking pressure 303 in the wheel brakes of the rear axle, the generator pressure equivalent 304 is subtracted from the driver's desired pressure 301. Consequently, a fluctuating generator axle moment 306 is compensated for by corresponding modulation of the rear axle pressure 303 and the vehicle deceleration corresponding to the driver's intentions is adjusted. As can be seen from the vehicle speed 305, the motor vehicle is braked to a standstill; as a result of the decreasing generator power at low speeds, the rear axle pressure 303 corresponds at the end of the braking operation to the driver's intentions 301 or the system pressure which is necessary for a purely hydraulic braking operation.

The modulation of the braking pressure 303 at the rear axle is carried out by closing or opening the inlet valves 15-c, 15-d and/or opening or closing the outlet valves 16-c, 16-d. If the brake system is controlled according to the second embodiment of the method according to the invention, the desired vehicle deceleration can be ensured with the brake force distribution being at an optimum level at the same time.

Since the modulation of the axle pressure by means of the wheel valves, depending on the technical construction of the valves, can produce for the driver noticeable undesirable noise, a third embodiment of the method according to the invention or the functionality for adjusting suitable braking pressures is explained below. In order to prevent any valve switching noises or to bring them to a level which cannot or can scarcely be perceived by the driver, the inlet valves 15-c, 15-d of the wheel brakes of the rear axle are advantageously switched at the beginning of a recuperative braking operation, that is to say, closed as illustrated in FIG. 3, and opened again only after the vehicle has stopped.

Consequently, a constant braking pressure is present during the recuperative braking at the rear axle. Preferably, that pressure is 0 bar or almost 0 bar, whereby braking is carried out with the rear axle in an almost exclusively recuperative manner. The remaining brake power necessary is produced by corresponding variation of the system pressure in the hydraulic pressure chamber 18 or the pressure in the wheel brakes 2-a, 2-b of the front axle. This is non-critical in relation to the driving stability since substantially greater braking moments can be applied at the front axle than at the rear axle because of the axle load shift.

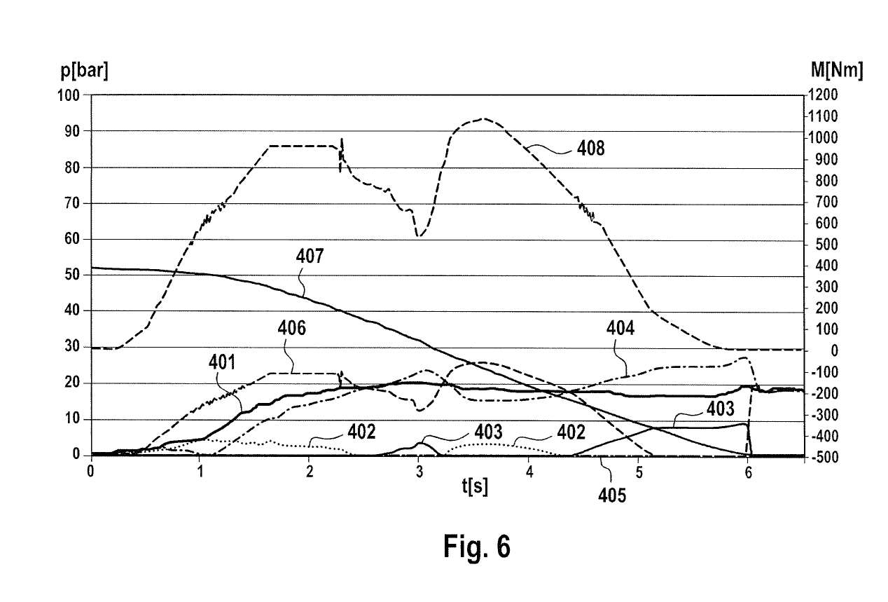

FIG. 6 illustrates an example of a braking operation according to that third embodiment of a method according to the invention, wherein pressure p and braking moment M are accordingly set out over time t. The line 401 sets out the driver's desired pressure, line 404 sets out the braking pressure in the wheel brakes of the front axle, line 408 sets out the generator braking moment and the line 406 sets out the generator pressure equivalent. As can be seen from the vehicle speed 407, the motor vehicle is again braked to a standstill. The wheel brakes 2-c, 2-d of the rear axle HA are pressureless up to the vehicle coming to a stop (the rear axle pressure 405 is zero during the entire braking operation), therefore the entire variation of the necessary friction braking power is implemented by variation of the system pressure or front axle pressure 404. To this end, a subtractive front axle pressure 402 and an additive front axle pressure 403 which result from the generator pressure equivalent 406 are accordingly calculated with the driver's desired pressure 401. With respect to a purely hydraulic braking operation, the braking pressure in the wheel brakes 2-a, 2-c of the front axle is therefore reduced with respect to the driver's desired pressure 401 (subtractive front axle pressure 402) or increased (additive front axle pressure 403). Consequently, a fluctuation of the generator axle moment as a result of corresponding modulation of the system pressure or front axle pressure 404 is compensated for and the vehicle deceleration corresponding to the driver's desired pressure 401 is adjusted.

In that the inlet valves 15-c, 15-d of the rear axle wheel brakes are closed during the entire braking operation (and an actuation of the outlet valves 16-c, 16-d is unnecessary), a generation of noise is prevented. The advantage of a cylinder/piston arrangement with a piston which can be displaced electrically with respect to, for example, a piston pump, according to which a pressure reduction can also be brought about without solenoid valves being actuated, is used to increase the driving comfort.

1. A method for operating a brake system for motor vehicles having an electrically controllable pressure provision device which comprises a cylinder/piston arrangement having a hydraulic pressure chamber and a piston which can be displaced by an electromechanical actuator, having a number of hydraulic wheel brakes which are associated with two axles of the vehicle and which can be supplied with braking pressure via the hydraulic pressure chamber, and having a sensor for detecting the driver's desired braking action, wherein an electric drive which can also be operated as a generator and which has at least one electrical machine is associated with at least one axle of the motor vehicle and, during recuperative braking, in which a generator deceleration is produced by the electric drive, the cylinder/piston arrangement is controlled in such a manner that the pressure in the hydraulic pressure chamber is adjusted in accordance with the difference between the required braking deceleration and the generator deceleration produced by the electric drive.

2. The method as claimed in claim 1, wherein all the wheel brakes are connected to the hydraulic pressure chamber during recuperative braking.

3. The method as claimed in claim 1, wherein the wheel brakes are separated at least temporarily from the hydraulic pressure chamber during recuperative braking at one axle, on which the electric drive which is operated as a generator acts.

4. The method as claimed in claim 3, wherein at least each wheel brake which is associated with an electrically driven axle acts on the electric drive which is operated as a generator, has an inlet valve which is opened without current, which is arranged between the hydraulic pressure chamber and wheel brake and an outlet valve which is closed without current, which is arranged between the wheel brake and a pressureless storage container, wherein the braking pressure during recuperative braking is modulated in at least one, wheel brake which is/are associated with the electrically driven axle by the inlet valves and/or the outlet valves being switched.

5. The method as claimed in claim 3, wherein at least each wheel brake which is associated with an electrically driven axle on which the electric drive operated as a generator acts, has an inlet valve which is opened without current, which is arranged between the hydraulic pressure chamber and the wheel brake, wherein the wheel brakes of the electrically driven axle are separated from the hydraulic pressure chamber for the entire duration of recuperative braking.

6. The method as claimed in claim 5, wherein the duration of the recuperative braking is established on the basis of the driver's desired braking action or a stopping of the motor vehicle, wherein the wheel brakes associated with an electrically driven axle are also separated from the hydraulic pressure chamber when the generator deceleration has been selected to be zero and has been replaced completely by hydraulic braking pressure.

7. The method as claimed in claim 1, wherein the brake system further has a main brake cylinder which can be actuated by the driver via a brake pedal and which is connected to all the wheel brakes via brake lines, and at least one separation valve which is opened without current, which is arranged between the main brake cylinder and the wheel brakes, wherein the main brake cylinder is separated from the wheel brakes during recuperative braking.

8. The method as claimed in claim 7, wherein the brake system further has a pedal simulator which can be connected to the main brake cylinder via a simulator valve which is closed without current, wherein the simulator valve is opened during regenerative braking.

9. The method as claimed in claim 7, wherein an actuation displacement sensor which is arranged on the brake pedal or the main brake cylinder and/or a pressure sensor which is connected to the main brake cylinder is/are evaluated as a sensor for detecting the driver's desired braking action.

10. The method as claimed in claim 1, wherein the entire braking deceleration required is built up by the electric drive up to a predetermined maximum value, wherein the maximum value is selected in accordance with the generator power and/or the vehicle speed and/or the charge level of a battery which is connected to the electric drive.

11. The method as claimed in claim 1, wherein a wheel speed sensor is arranged on each wheel of the motor vehicle, wherein the generator deceleration is limited or reduced if a slippage magnitude which is established on the basis of a relationship between a wheel speed of a wheel connected to the electric drive and a free-wheeling wheel, exceeds a predetermined slippage threshold value.

12. A brake system for a motor vehicle, having an electrically controllable pressure provision device which comprises a cylinder/piston arrangement having a hydraulic pressure chamber and a piston which can be displaced by an electromechanical actuator, having a number of hydraulic wheel brakes which are associated with two axles of the motor vehicle and which can be supplied with braking pressure via the hydraulic pressure chamber, and having a sensor for detecting the driver's desired braking action, an electric drive which can also be operated as a generator and which has at least one electrical machine is associated with at least one axle of the vehicle, and the brake system comprises an electronic control device which carries out a method according to claim 1.

13. The brake system as claimed in claim 12, wherein a hydraulic wheel brake and a wheel speed sensor are arranged on each wheel of the motor vehicle, wherein each wheel brake has an inlet valve, which is opened without current, which is arranged between the hydraulic pressure chamber and the wheel brake, and an outlet valve which is closed without current, which is arranged between the wheel brake and a pressureless storage container.

14. The brake system as claimed in claim 12, wherein a main brake cylinder which can be actuated by the driver via a brake pedal and which is connected to all the brakes via brake lines, at least one separation valve, which is opened without current, which is arranged between the main brake cylinder and the wheel brakes, and a pedal simulator which can be connected to the main brake cylinder via a simulator valve which is closed without current.

15. The use of a brake system as claimed in claim 12 in a motor vehicle, wherein an electric drive is associated with at least the front axle.

16. The use of a brake system as claimed in claim 12, wherein an electric drive is associated with the rear axle.

17. The method as claimed in claim 8, wherein an actuation displacement sensor which is arranged on the brake pedal or the main brake cylinder and/or a pressure sensor which is connected to the main brake cylinder is/are evaluated as a sensor for detecting the driver's desired braking action.

18. The brake system as claimed in claim 13, wherein a main brake cylinder which can be actuated by the driver via a brake pedal and which is connected to all the brakes via brake lines, at least one separation valve which is opened without current, which is arranged between the main brake cylinder and the wheel brakes, and a pedal simulator which can be connected to the main brake cylinder via a simulator valve which is closed without current.
